(19) United States
(12) Patent Application Publication
(10) Pub. No.: US 2004/0227818 A1
(43) Pub. Date: Nov. 18, 2004

(54) System and an associated method for displaying user information

(75) Inventors: Peter Wiedenberg, Feucht (DE); Soeren Moritz, Wimmelbach (DE); Thomas Jodoin, Schwabach (DE)

Correspondence Address: SUGHRUE MION, PLLC, 2100 PENNSYLVANIA AVENUE, N.W., SUITE 800, WASHINGTON, DC, 20037, US

(73) Assignee: SIEMENS AG

(21) Appl. No.: 10/784,836

(22) Filed: Feb. 24, 2004

Related U.S. Application Data
(63) Continuation of application No. PCT/DE02/02956, filed on Aug. 12, 2002.

(30) Foreign Application Priority Data
Aug. 24, 2001 (DE) 10141521.4

(51) Int. Cl. H04N 5/225

(52) U.S. Cl. 348/207.1

(57) ABSTRACT

A system and a method for displaying user information, which improves the simultaneous display of user information and image information regarding an environment. The system comprises the following elements: a camera (1) for acquiring image information (2) of a section of an environment, wherein a zoom device (3) for changing the size of the detected section according to a zoom factor and/or a device (4) for the three-dimensional orientation of the camera (1) according to a space vector is provided; a computer unit (5) for computing the position coordinates (12) of the image information (2) using the space coordinates of the camera (1) and/or the control variables “zoom factor” and “space vector”, for assigning user information (6) to the position coordinates (12), and for computing positions of representations (13) of the image information (2) on a display area (7) of a display device (8); and an image processing unit (9) for processing the image information (2) and the user information (6) so as to reproduce the image information (2) and the user information (6) by means of the display device (8) and so as to insert the user information (6) in the proper location on the display area (7) at the positions of the representations (13) of the image information (2) that have position coordinates (12) to which the respective user information (6) is assigned.

This is a Continuation of International Application PCT/DE02/02956, with an international filing date of Aug. 12, 2002, which was published under PCT Article 21(2) in German, and the disclosure of which is incorporated into this application by reference.

### FIELD OF AND BACKGROUND OF THE INVENTION

This invention relates to a system and a method for displaying image information, which are detected by a camera, and for displaying user information on a display system.

Display systems are used to inform a user of the current status of a process. Based on detected process values and status data of a process control program, these systems display a current installation process status, with changing text or graphic elements (e.g., dynamic bars), as user information. The process values are detected by respective sensors, in which case the user information is limited to information that can be detected by the sensors and/or that is reflected in the status of the control program—however, not everything can be detected by sensors. For this reason, video technology is being used increasingly. By means of a recorded video image, the visible status of the process and the process environment is displayed to the user on the display system. This video image shows only visible states, but not states that are displayed in a physically different way (such as the temperature in a tank or the status of the control program in the computer system memory). Therefore, conventionally, for a complete display of information, either the display screen area of the display system had to be split or the user had to switch back and forth between different images of the display system.

### OBJECTS OF THE INVENTION

It is one object of this invention to improve a simultaneous display of user information and image information of a camera environment.

### SUMMARY OF THE INVENTION

According to one formulation of the present invention, this and other objects are achieved by a system for displaying user information, wherein the system includes a camera for acquiring image information of a section of an environment.

The system further includes a zoom device to change the size of the section in accordance with a zoom factor and/or a device for three-dimensional orientation of the camera in accordance with a space vector. In addition, the system includes a computer unit that computes position coordinates of the image information based on space coordinates of the camera and/or based on the control variables “zoom factor” and “space vector”. The computer unit also assigns the user information to the position coordinates and computes the positions of representations of the image information on a display area of a display device.

Moreover, the system includes an image processing unit for processing the image information and the user information so as to reproduce the image information and the user information on the display device, and so as to insert the user information in the proper location on the display area at the positions of the representations of the image information that have position coordinates, to which the respective user information is assigned.

According to another formulation of this invention, this and other objects are achieved by a method of displaying user information, in which image information of a section of an environment is acquired with a camera. A zoom unit is provided for changing the size of the detected section in accordance with a zoom factor and/or, by using a device, the camera is oriented three-dimensionally in accordance with a space vector. A computer unit computes position coordinates of the image information based on space coordinates of the camera and/or based on the control variables “zoom factor” and “space vector”. The computer unit assigns user information to the position coordinates and computes positions of representations of the image information on a display area of a display device.

Further, an image processing unit processes the image information and the user information so as to reproduce the image information and the user information with the display device, and so as to insert the user information in a proper location on the display area at the positions of the representations of the image information having the position coordinates, to which the respective user information is assigned.

The inventive system and/or method permits dynamic insertion of user information—e.g., process values, status information of a control program—into the image of a section of an environment that is displayed to the user. This image is recorded by a camera that is movable and/or offers the option of changing the size of the image section by means of a zoom unit. Thus, the camera need not have a fixed image section. Instead, the image section can be freely defined (orientation and/or zoom factor). In the present invention, the user information to be inserted need not be based on a static image with regard to camera orientation and zoom factor. Instead, the user information obtain a reference to the real position coordinates of the image information in the section currently detected by the camera. The user information regarding the currently visible section is automatically inserted at the proper location.

Therein, if the viewing angle of the camera changes, i.e., if the camera moves (e.g., rotation or tilt, zoom factor), the positions of the dynamic insertions do not change with respect to the representations of the image information (e.g., of objects) that are visible on the display area of the display device.

In an advantageous embodiment of this invention, the computer unit includes a triggering unit for triggering the camera, the zoom device and/or the device for three-dimensional orientation of the camera in accordance with the control variables “zoom factor” and/or “space vector”. Thus, the computer unit already knows these control variables. The computer unit can use these control variables directly for computing the position coordinates of the image information of the section of the environment.

This system can be made particularly user friendly in that the image processing unit selects and inserts the user information as a function of the zoom factor. For example, in a wide-angle view, it is conceivable that user information, e.g., object names, is only inserted for individual objects on the display area. If the camera zooms in on these objects, detailed information could be displayed, e.g., the filling level, the temperature, or the like. The current detailed information would be read out of an operation and observation system. Thus, in this embodiment, the user information is formed as a combination of static and dynamic information. In addition to inserting dynamic information, which results from process interfacing, for example, any other data sources can also be connected, e.g., a connection to databases with static information or to Internet web pages.

For simple further processing of the image information detected by the camera, the camera is advantageously designed as a video camera and the display device is designed as a display screen. The image data supplied by the video camera is processed by the image processing unit for reproduction on the screen.

To give the user more operation options, it is proposed that the triggering unit for triggering the camera, the zoom device, and the device for three-dimensional orientation of the camera has a unit that is operated by the user. Thus, the camera can be moved by, e.g., a remote control, independently of the computer unit.

In another embodiment of this invention, the user information is inserted on the display area in accordance with an imaging procedure/protocol or representation procedure/protocol. Such an imaging procedure/protocol contains specific rules, formats and links, in accordance with which the respective user information is displayed.

### BRIEF DESCRIPTION OF THE DRAWINGS

The present invention is described in greater detail below based on exemplary embodiments illustrated in the figures, in which:

FIG. 1 shows a schematic overview of a system for displaying user information;

FIG. 2 shows a section of the system including a PC and a video camera; and

FIG. 3-FIG. 5 show views of a display area of a display device at different control variables “space vector” and “zoom factor”.

### DETAILED DESCRIPTION OF THE PREFERRED EMBODIMENTS

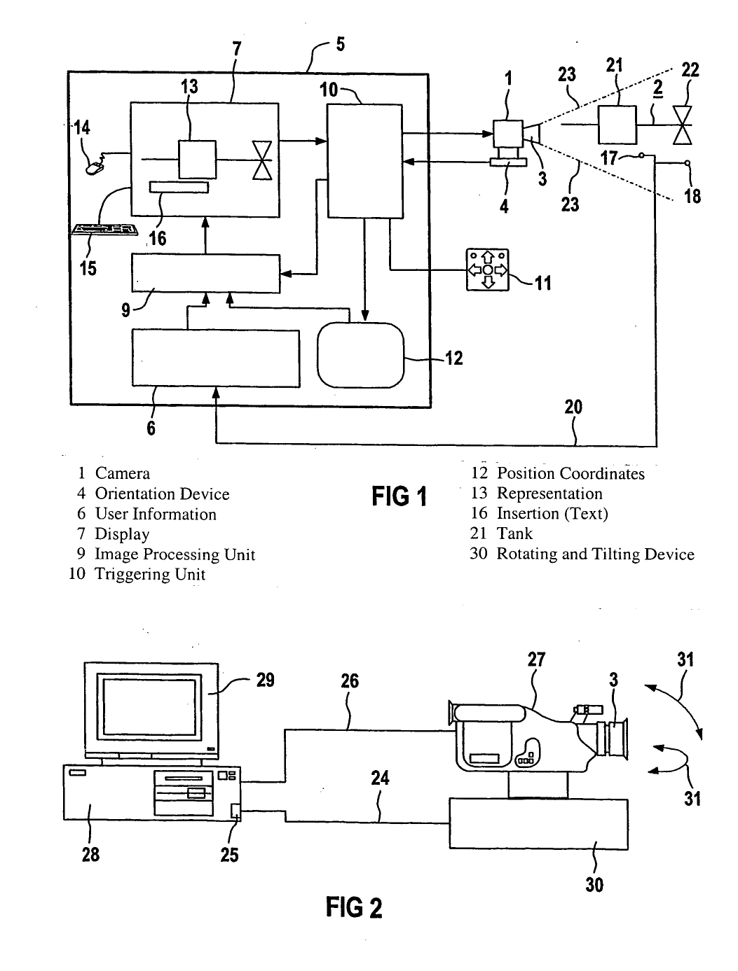

FIG. 1 shows a schematic overview of an exemplary embodiment of a system for displaying user information. A camera 1 acquires or detects image information 2 of a section of the environment of the camera 1. In the exemplary embodiment of FIG. 1, the image information 2 represents a view at a tank 21 that has a valve 22. The viewing angle 23 of the camera 1, which detects an image of a section of the environment, is depicted in a stylized manner. The camera 1 is mounted on a device 4 for three-dimensional orientation of the camera and has a zoom device 3. The camera 1 and the device 4 are connected to a computer unit 5. The computer unit 5 has a drive unit or triggering unit 10 and a display area 7. In addition, the computer unit 5 has user information 6, which, in the exemplary embodiment, is supplied by measuring points 17, 18 via a process interface 20. In an image processing unit 9, the user information 6 is linked to position coordinates 12. Further, the user information is displayed on the display area 7 as insertion 16, together with a representation 13 of the image information 2. Moreover, the computer unit 5 has various input units for a user, namely a computer mouse 14, a keyboard 15 and other units 11 that can be operated by a user.

The basic operation of the proposed system is explained below based on FIG. 1. In the exemplary embodiment, the camera 1 picks up the objects 21, 22, which lie within its viewing angle 23, as the image information 2. The aperture angle of the viewing angle 23 is adjustable with a zoom device 3, e.g., by adjusting the focal length. In addition, the orientation of the viewing angle 23 is adjustable by rotating or tilting the camera 1. The variable size of the aperture angle of the camera 1 is known as the zoom factor, which is an important control variable of the system. Depending on the zoom factor, the camera 1 picks up a larger or smaller section of its environment. The camera 1 is mounted on a device 4 for the camera's three-dimensional orientation. Thus, the camera 1 is rotatable about two of its axes of movement. The device 4 for three-dimensional orientation is driven by a motor drive or a pneumatic drive, for example. The movement of the device 4, the adjustment of the zoom device 3, and the functions of the camera 1 are controlled by the triggering unit 10 of the computer unit 5.

The orientation of the camera 1 in space is described by the control variable “space vector”. The camera 1 and the device 4 for three-dimensional orientation send actual values for the space vector and the zoom factor back to the computer unit 5. If the camera can execute not only rotational and tilting movements but also linear movements, the positioning of the camera 1 in space is defined in the form of space coordinates of the camera 1. The computer unit 5 has access to additional information regarding the environment of the camera 1, e.g., in the form of a model which describes the essential points of the environment's objects 21, 22 in the form of space coordinates or vectors. Thus, the computer unit 5 has sufficient information to determine the position coordinates 12 of the image information 2 detected by the camera 1. The position coordinates 12 are computed from the control variables “zoom factor” and “space vector” and—in the case of linear movements—from the space coordinates of the camera 1. The size and position of the camera's viewing angle 23 in space are determined from the result of this computation. By forming an intersection with the information about the environment, it is possible to determine which objects 21, 22 are detected in which view by the camera 1 as the image information 2.

The image processing unit 9 of the computer unit 5 processes the image information 2 so that the image information 2 is displayed on the display area 7 of the display device as a two-dimensional representation 13 of the objects 21, 22. Based on the computation of the position coordinates 12, information about the position of the representation 13 of the image information 2 and/or the objects 21, 22 on the display area 7 is also available. In a memory of the computer unit 5 or in external memory units, to which the computer unit 5 has access, the user information 6 is assigned to respective, specific position coordinates 12. If the image processing unit 9 of the computer unit 5 recognizes that the image information 2 from the objects 21, 22 is detected by the camera 1 with these specific position coordinates 12, then the image processing unit 9 inserts the corresponding user information 6, together with the representation 13, on the display area 7. Since the position of the representation 13 of the objects 21, 22 is known, the user information 6, which is assigned to these objects via the position coordinates 12, can be inserted in the proper location, e.g., in direct proximity to the representation 13. If the camera 1 moves or the zoom device 3 is adjusted, the actual values of the control variables “space vector” and “zoom factor” change continuously and, accordingly, the observed section of the environment also changes. Thereby, the position of the representation 13 on the display area 7 changes too. However, by real-time computation of the position coordinates 12, the changed position of the representation 13 on the display area 7 can be calculated. Further, the user information 6 can still be inserted in the proper location relative to the representation 13, even if the position of the user information 6 on the display area 7 is shifted. Thus, if the position coordinates 12 are assigned to the user information 6, and if the current orientation (space vector) of the camera 1, the current zoom factor, and—in the case of a linear movement of the camera 1 in space—the space coordinates of the camera 1 (i.e., the camera's position in space) are known, then, for the overlay technique, the insertion and positioning of the user information 6 can be computed instantaneously. Therefore, the user information 6 for the currently visible section can always be inserted at the respectively proper location.

The user information 6 may be dynamic or static information or a combination thereof. Dynamic information includes, for example, process values. In an exemplary embodiment, an installation having a tank 21 and a valve 22 is located in the field of vision of the camera 1. A temperature sensor 17 is mounted on the tank 21, and a measurement device 18 for the opening state of the tank 21 is mounted on the valve 22. The detected process values “temperature” and/or “valve opening” are transmitted to the computer unit 5 via the process interface 20. There, the process values “temperature” and/or “valve opening” are then available as user information 6 and inserted at the proper location in the representation of the objects 21, 22. Thus, by the additionally inserted process variables, the representation of the objects 21, 22 displayed to the user is supplemented with the user information 6. The user is able to operate the computer unit 5 by using the input units 14, 15. In addition, the user has the option to directly specify the orientation and the zoom factor of the camera 1 via the units 11.

FIG. 2 shows another exemplary embodiment of this invention, in which the camera 1 is designed as a video camera 27, the computer unit 5 is designed as a personal computer 28, and the display device is designed as a display screen 29. Further, in this exemplary embodiment, the device 4 for three-dimensional orientation, on which the video camera 27 is mounted, is designed as a rotating and tilting device 30. The degrees of freedom of the video camera 27 are indicated by arrows 31. Via a camera triggering device, the personal computer 28 is capable of adjusting the controllable video camera 27 with respect to its zoom and position. The image information 2 recorded by the video camera 27 is sent, as a video signal 26, to the personal computer 28 and/or to a so-called frame grabber card in the personal computer 28. With the frame grabber card and the respective software, it is possible to display the video image of the video camera 27 on the display screen 29. The rotating and tilting device 30 (pan, tilt) and the zoom device 3 of the video camera 27 are connected to a serial interface 25 of the personal computer 28 via an RS232 connection 24. Via a respective protocol (VISCA), the video camera 27 can be moved by software and the resulting viewing angles can be read out. The video camera 27 can also be moved by a remote control (not shown in FIG. 2), independently of the personal computer 28.

Since, with each video frame to be displayed on the screen 29, the respective data for rotation, tilt and zoom factor is read out of the video camera 27, it is possible to dynamically insert the user information 6 in the proper location, regardless of whether the video camera 27 has been moved by software or by the remote control. By an imaging procedure or representation procedure, it is possible to insert supporting text into the video image, for example. Thus, the special advantage of the system and method proposed lies in the dynamic insertion of information into the video image, wherein the section that is currently picked up by the video camera 27 is taken into account. Therein, when the video camera 27 moves (rotation and/or tilt, zoom factor), the dynamic insertions do not change their positions with respect to the objects visible on the video image. Only as a result of lens distortion of the video camera 27 and as a result of perspective distortion do the dynamic insertions slightly move with respect to the visible objects.

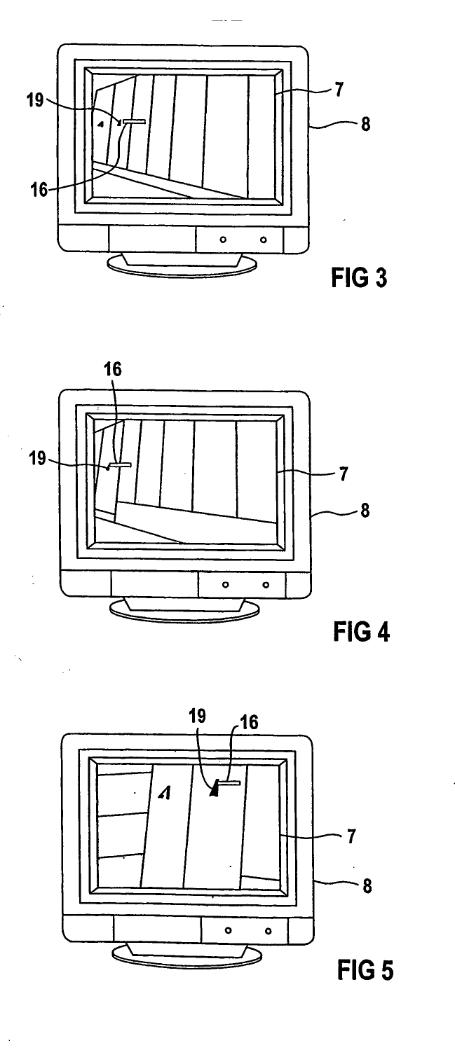

FIG. 3 through FIG. 5 each show the same display device 8 having a display area 7 at different viewing angles of the camera 1 in accordance with the exemplary system of the invention shown in FIG. 1. The image picked up by the camera 1 and projected onto the display area 7 shows an arrangement of switch cabinets. A supplementary text 16 at the opening lever 19 of a switch cabinet is inserted into the image displayed. In FIG. 4, the viewing angle has slightly changed due to rotation of the camera 1. In FIG. 5, the camera has zoomed in on the switch cabinet and the viewing angle has shifted again. In all three figures, the text 16 appears to “stick” to the opening lever 19 because, in the computer unit 5, the text 16 and the video image are combined into one image from the position data by means of an imaging procedure/protocol or representation procedure/protocol. This is possible because, for each video image, the current position settings and zoom settings of the camera 1 are read out too. In addition, depending on the zoom, more or less data can be inserted into the image. For example, it is conceivable that, in a wide-angle image, only individual objects may be identified (e.g., tank 1, switch cabinet 2). If the user zooms in on these elements, detailed information could be displayed (e.g., tank 1: filling level 3 m). This current data would be read out from an operation and observation system.

Thus, in summary, this invention relates to a system and a method for displaying user information, in which the simultaneous display of user information and image information about an environment is improved. According to one of the embodiments described, the system includes a camera 1 for acquiring image information 2 of a section of an environment. A zoom device 3 for changing the size of the acquired section according to a zoom factor and/or a device 4 for changing the three-dimensional orientation of the camera 1 according to a space vector is provided. Further, the system includes a computer unit 5 for computing the position coordinates 12 of the image information 2 based on the space coordinates of the camera 1 and/or based on the control variables “zoom factor” and “space vector”. In addition, the computer unit 5 assigns the user information 6 to the position coordinates 12 and computes the positions of the representations 13 of the image information 2 on the display area 7 of the display device 8. The system further includes an image processing unit 9 for processing the image information 2 and the user information 6 so as to reproduce them with the display device 8 and so as to insert the user information 6 in the proper location on the display area 7. Therein, the user information 6 is inserted at the positions of the representation 13 of the image information 2 via the position coordinates 12, which are assigned to the respective user information 6.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof

What is claimed is:

1. A system for displaying user information, comprising:
a camera configured to acquire image information of a section of an environment;
at least one of a zoom device configured to alter a size of the section in accordance with a zoom factor and a device configured for three-dimensional orientation of the camera in accordance with a space vector;
a computer unit,
wherein the computer unit is configured to compute position coordinates of the image information based on at least one of space coordinates of the camera, the zoom factor, and the space vector;
wherein the computer unit is configured to assign the user information to the position coordinates; and
wherein the computer unit is configured to compute positions of representations of the image information on a display area of a display device; and
an image processing unit for processing the image information and the user information so as to reproduce the image information and the user information with the display device and so as to insert the user information in a location on the display area at the positions of the representations of the image information having the position coordinates to which the respective user information is assigned.

2. The system as claimed in claim 1, wherein the computer unit comprises a triggering unit configured to trigger at least one of the camera, the zoom device, and the device for three-dimensional orientation of the camera in accordance with at least one of the zoom factor and the space vector.

3. The system as claimed in claim 1, wherein the image processing unit is configured to select and insert the user information as a function of the zoom factor.

4. The system as claimed in claim 1, wherein the user information comprises at least one of static and dynamic information.

5. The system as claimed in claim 1, wherein the camera comprises a video camera and the display device comprises a display screen.

6. The system as claimed in claim 2, wherein the triggering unit comprises an operator interface.

7. The system as claimed in claim 1, wherein the image processing unit is provided for processing the image information and the user information, for reproducing the image information and the user information with the display device, and for inserting the user information in the location on the display area in accordance with an imaging procedure.

8. A method of displaying user information, comprising:
acquiring image information of a section of an environment with a camera;
at least one of altering a size of the section in accordance with a zoom factor utilizing a zoom device and orienting the camera three-dimensionally in accordance with a space vector utilizing a device;
with a computer unit, computing position coordinates of the image information based on at least one of space coordinates of the camera, the zoom factor, and the space vector;
with the computer unit, assigning the user information to the position coordinates;
with the computer unit, computing positions of representations of the image information on a display area of a display device; and
with an image processing unit, processing the image information and the user information so as to reproduce the image information and the user information with the display device and so as to insert the user information in a location on the display area at the positions of the representations of the image information having the position coordinates, to which the respective user information is assigned.

9. The method as claimed in claim 8, wherein, by using a triggering unit, the computer unit triggers at least one of the camera, the zoom device, and the device for three-dimensional orientation of the camera in accordance with at least one of the zoom factor and the space vector.

10. The method as claimed in claim 8, wherein the image processing unit selects the user information and inserts the user information as a function of the zoom factor.

11. The method as claimed in claim 8, wherein the user information comprises at least one of static and dynamic information.

12. The method as claimed in claim 8, wherein the camera comprises a video camera and the display device comprises a display screen.

13. The method as claimed in claim 9, wherein at least one of the camera, the zoom device, and the device for three-dimensional orientation of the camera is operated by a user by using a unit of the triggering unit.

14. The method as claimed in claim 8, wherein the image processing unit processes the image information and the user information for reproduction with the display device and for insertion of the user information in the location on the display area in accordance with an imaging procedure.
